(19) United States
(12) Patent Application Publication
(10) Pub. No.: US 2012/0040856 A1
(43) Pub. Date: Feb. 16, 2012

(54) METHOD FOR DETECTING THE PRESENCE OF LIQUIDS IN A MICROFLUIDIC DEVICE, DETECTING APPARATUS AND CORRESPONDING MICROFLUIDIC DEVICE

(75) Inventors: Enrico Alessi, Catania (IT); Giovanni Di Trapani, Palermo (IT); Antonella Licciardello, Misterbianco (IT)

(73) Assignee: STMICROELECTRONICS S.R.L., Agrate Brianza (IT)

(21) Appl. No.: 13/167,595

(22) Filed: Jun. 23, 2011

Related U.S. Application Data
(63) Continuation-in-part of application No. PCT/EP2009/067805, filed on Dec. 22, 2009.

(30) Foreign Application Priority Data
Dec. 23, 2008 (IT) TO2008A000972

(51) Int. Cl. C40B 30/04; C40B 40/06

(52) U.S. Cl. 506/9; 506/16

(57) ABSTRACT

A method for detecting the presence of liquids includes detecting an initial temperature in a channel accommodating a liquid; heating the channel for a pre-determined test time; detecting a test temperature; determining a temperature variation on the basis of the initial temperature, the test temperature, and the test time; and comparing the temperature variation with at least one threshold. Before detecting an initial temperature, an ambient temperature is read, the channel is heated to the initial temperature, and is kept at the initial temperature for a time period.

### BACKGROUND

1. Technical Field

The present disclosure relates to a method for detecting the presence of liquids, in particular in a microfluidic device for detecting biological materials, such as nucleic acids, proteins, lipids, carbohydrates, and the like.

In the particular case considered, the disclosure falls within the issue of diagnosing pathological conditions or more in general of studying DNA via development of “disposable” labs-on-chip and is aimed at introducing automatic techniques for controlling the operations of preparation and introduction of the biological specimens.

2. Description of the Related Art

As is known, the identification of sequences of specific biological materials is important in many areas including clinical diagnosis, environmental diagnosis, and diagnosis of microbiological foodstuffs. In particular, the analysis of sequences of genes plays a fundamental role in fast detection of genetic mutations and infected organisms. This means that it is possible to make reliable diagnoses of pathological conditions even before appearance of any symptom.

Typical procedures for analysis of biological materials, such as nucleic acids, proteins, lipids, carbohydrates, and other biological molecules, use different operations starting from the raw material.

These operations may include various degrees of separation or purification of cells, lysis, amplification, and analysis of the products of amplification or purification.

For example, in DNA-based blood analyses, the specimens are frequently purified by filtration, centrifugation, or electrophoresis so as to eliminate all the non-nucleated cells, which generally are not useful for DNA analysis. Then, the remaining white blood cells are broken up or lysed using chemical, thermal, or biochemical means in order to free the DNA to be analyzed. Next, the DNA is denatured by thermal, biochemical, or chemical processes and amplified by an amplification reaction, such as polymerase-chain reaction (PCR), ligase-chain reaction (LCR), strand-displacement amplification (SDA), transcription-mediated amplification (TMA), rolling-circle amplification (RCA), and the like. The amplification step enables the operator to avoid studying purification of DNA since the amplified product considerably exceeds the starting DNA in the specimen.

If RNA is to be analyzed, the procedures are the same, but more emphasis is placed on purification or other means for protecting the labile RNA molecules. RNA is usually copied into DNA (cDNA) and then the analysis proceeds as described for DNA.

Finally, the amplification product undergoes some type of analysis, usually based on sequence or size or a combination thereof A common technique of analysis is hybridization analysis, where the amplified DNA is passed over a plurality of detectors made up of individual oligonucleotide detector fragments that are anchored on suitable substrates. The detecting fragments, or “probes”, can be complementary to the strands of amplified target DNA. In this case, stable bonds are formed between the strands (hybridization). The presence of double-helix DNA in the mixture is thus indicative of a matching, and hybridization serves as mechanism for detecting the sequence.

In hybridization reactions, the probes, generally arranged in microarrays, are bound to the amplification product marked by the use of fluorochromes, i.e., molecules that are able to absorb electromagnetic radiation of a certain wavelength and emit a fraction of the absorbed energy, with a radiation wavelength that is different from and generally higher than the absorbed one. The images acquired are formed by light spots (hybridization signal) on a background with a very low luminosity level. In particular, the images are processed using a suitable bio-software, which enables, in addition to extracting the raw data, setting the operation mode and chamber parameters, displaying the image, and saving them in a suitable format.

It is thus clear that the amplification, which can occur within a same chip where detection is carried out starting from a relatively small specimen, represents an important advantage, from the standpoint of costs and time, as compared to other methods that frequently require acquisition of more voluminous specimens, which are costly to acquire and extract and have to be analyzed in remote laboratories, with expensive and cumbersome equipment and risks of contamination.

In any case, the amplified quantity of the specimen is strictly dependent upon the quantity of specimen introduced initially in the amplification chamber of the chip. Consequently, the step of introducing the specimen within the chip is very important to obtain reliable results and may be critical since its execution and control are managed totally by the operator and are subject to the error due to his precision.

In particular, the absence of the specimen or the introduction of a quantity smaller than necessary may entail a negative outcome of the test. Consequently, when evaluating a test with a negative outcome, there exists the uncertainty that the result of the test has been conditioned by an initial error linked to the specimen quantity.

### BRIEF SUMMARY

To overcome the above limitation, it is desirable to adopt a procedure that verifies the presence of the specimen to be analyzed before the test is conducted.

Consequently, one embodiment of the disclosure provides a fast and accurate procedure for verifying the presence or absence in the device of a specimen to be analyzed.

According to the present disclosure there are provided a method for detecting the presence of liquids, a detecting apparatus, and a corresponding microfluidic device, as defined in claims 1, 7 and 10, respectively.

### BRIEF DESCRIPTION OF THE SEVERAL VIEWS OF THE DRAWINGS

For an understanding of the present disclosure a preferred embodiment thereof is now described, purely by way of non-limiting example, with reference to the attached drawings, wherein:

FIG. 1 is a simplified cross-section of a chip integrating an embodiment of a microfluidic device to which the present method is applied;

FIG. 2 is a simplified block diagram of an apparatus for detecting hybridization using the chip of FIG. 1;

FIG. 3 shows a simplified block diagram of the temperature-control system of the apparatus of FIG. 2;

FIG. 4 shows a portion of the chip of FIG. 1, which highlights the heat flow during heating;

FIGS. 5 and 6 show the temperature variation in the chip of FIG. 1 in the absence and in the presence of liquid;

FIG. 7 is a flowchart corresponding to the present method; and

FIG. 8 shows an exemplary plot of temperature versus time with the present method.

### DETAILED DESCRIPTION

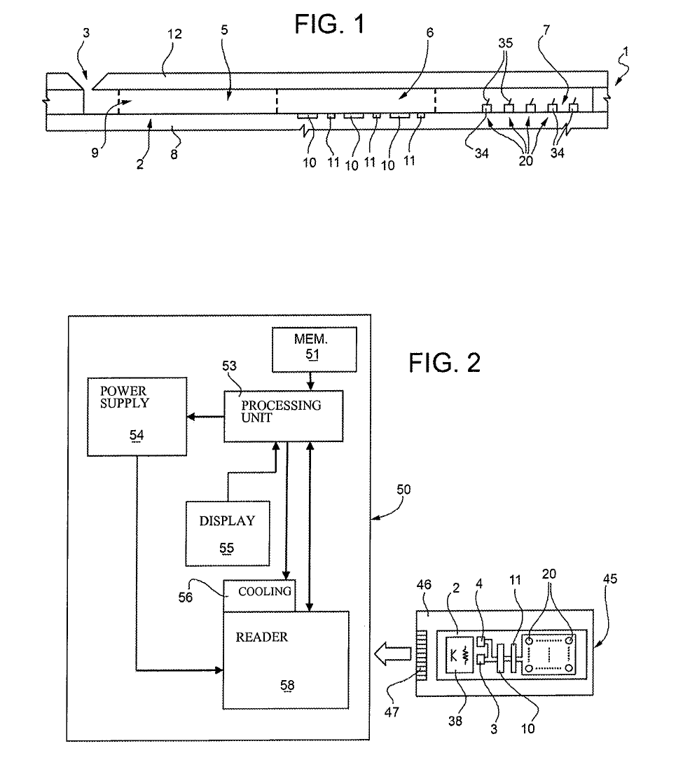

FIG. 1 shows a device 1, in particular an integrated microfluidic device, for example, a unit for detecting hybridization, which co-operates with an apparatus 50 for biochemical analyses, shown in FIG. 2.

The device 1 is here provided in a chip 2 integrating an array of probes 20 and associated electronic components, not visible in FIG. 1 and designated as a whole by 38 in FIG. 2. The electronic components 38 comprise, i.a., an input/output unit for exchanging commands and data between the device 1 and the apparatus 50.

Each probe 20 is here represented as made of a detection region 34, e.g., biotinylated DNA including probe fragments 35.

In the shown simplified example, the chip 2 comprises a substrate 8 of semiconductor material, for example silicon, accommodating one or more channels 9 (only one whereof shown in the drawings). The channel 9 here forms a specimen reservoir 3, a reagent reservoir 4 (FIG. 2), a specimen-preparation portion 5, an amplification chamber 6, and a detection chamber 7, in mutual fluidic connection.

The device 1 is also provided with a micropump (here not illustrated), for advancing the biological specimen and the reagents from the reservoirs 3, 4 towards the detection chamber 7, for example, arranged downstream and accommodating the probes 20.

The specimen reservoir 3 and the reagent reservoir 4 are open on one surface of the device 1 so as to be accessible from outside.

The specimen-preparation portion 5 may comprise a dielectrophoresis cell and a lysis chamber (not shown), for separating nucleated cells of the biological specimen from non-nucleated cells and filtering away the non-nucleated cells.

Heaters 10 and temperature sensors 11 are here represented as formed in the substrate 8, underneath the amplification chamber 6. Alternatively, they can be arranged on the surface of the device 1 (see, for example, U.S. Pat. No. 6,673,693, which is incorporated herein by reference in its entirety). The heaters 10 and the temperature sensors 11 are driven by a control unit (e.g., a processing unit 53 in FIG. 2), in order to heat and cool the amplification chamber 6 according to a pre-determined temperature profile (thermocycling). For example, four pairs of heaters 10-temperature sensors 11 may be provided.

The device 1 may be closed at the top by a plate or panel 12 (e.g., a slide), glued to the chip 2.

In the embodiment of FIG. 2, the device 1 is mounted on a cartridge 45, which is loaded into the apparatus 50. The apparatus 50 comprises, in addition to the processing unit 53, a memory 51, a power-supply generator 54, a display 55, a reader 58, and a cooling unit 56, all connected to the processing unit 53 for exchanging commands/information. The cartridge 45 comprises a board 46, which supports the device 1, and a cartridge interface 47 and may be removably inserted into the reader 58 for selective coupling to the processing unit 53 and to the power-supply generator 54. The heaters 10 are coupled to the power-supply generator 54 through the cartridge interface 47. Alternatively, the heaters 10 and the sensors 11 may be arranged on the board 46 or integrated in the reader 58. The cooling unit 56 may be a Peltier module or a fan, controlled by the processing unit 53 and thermally coupled to the cartridge 45 when inserted into the reader 58.

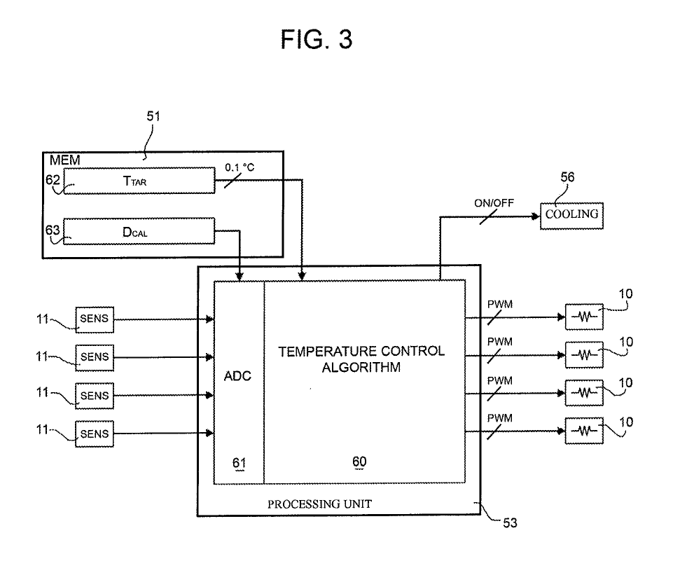

The heaters 10 and the temperature sensors 11 are connected to the processing unit 53 for controlling the temperature in the chip 1, in particular inside the amplification chamber 6. The corresponding hardware is represented as a whole in FIG. 3. In particular, this figure shows, of the processing unit 53, the part related to the temperature control, which includes an algorithm 60, for example, implemented with firmware technique, which has the function of handling the temperature sensors 11, the heaters 10, and the cooling unit 56.

The algorithm 60 is connected to the sensors 11 through an electronic interface, which forms a high-resolution analog-to-digital converter (ADC) 61, receiving signals correlated to the detected temperature and generating a temperature signal supplied to the algorithm 60. In the illustrated example, the ADC 61 is shown as forming part of the processing unit 53, but may be external thereto, for example integrated in the chip 1. The signals supplied by the sensors 11 are, for example, multiplexed before being supplied to the ADC 61.

The algorithm 60 is moreover connected to the heaters 10, for example through a driving stage of a pulse-width-modulation (PWM) type (not shown), integrated in the chip 1 or inside the apparatus 50 so as to vary the power supplied to the heaters 10 on the basis of the control algorithm.

The algorithm 60 receives desired temperature values (TTAR) 62 and sensor calibration data (DCAL) 63 from the memory 51, and activates/de-activates the cooling unit 56 so as to vary the cooling rate of the chip 1 on the basis of the thermal cycles envisaged for amplification.

According to one embodiment of the disclosure, the algorithm 60 comprises an automatic procedure, which, on the basis of an analysis of the temperature existing in the amplification chamber 6, controls the presence of a biological specimen within the chip 1 before transferring the specimen to the detection chamber 7, where the test or the desired analysis is conducted.

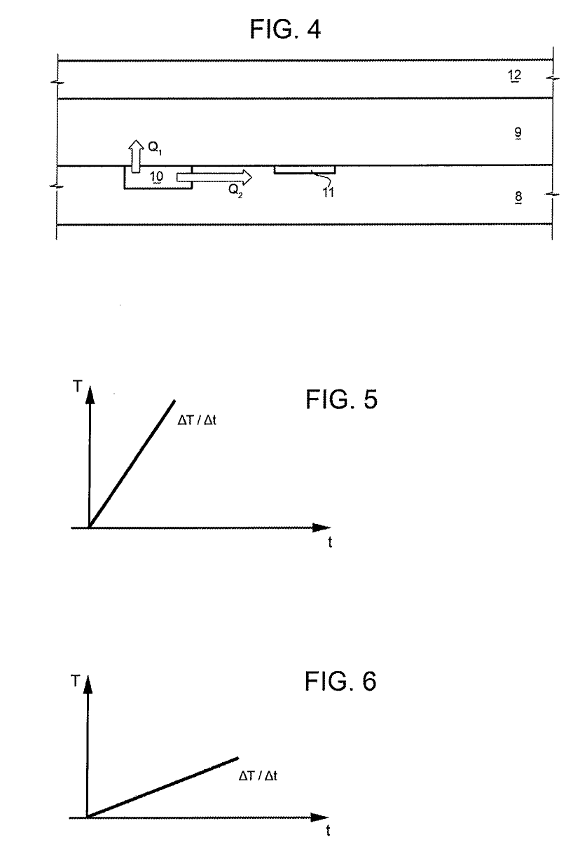

For a better understanding, reference may be made to FIG. 4, which shows an enlarged detail of the device 1 of FIG. 1. As may be noted, the heat Q generated by the Joule effect by each heater 10 includes two components: a first part Q1 propagates within the channel 9, while a second part Q2 (remaining part) propagates in the substrate 8 (Q=Q1+Q2). Thus the sensor 11 detects a detected heat amount Q3 equal to the sum of the second part Q2 and of a small fraction of the first part Q, due to propagation in the channel 9, i.e.,

Q3=Q2+kQ1=Q−(1−k)Q1.

With a same power supplied by the heater 10, and thus a same heat Q, the first part Q1 varies according to the presence or absence of liquid in the channel 9. In fact, in the presence of the liquid, the first part Q1 increases and the second part Q2 decreases, and, in the absence of liquid, the reverse occurs (in general, the liquid is a better thermal conductor than the air in the channel 9 in the absence of liquid). Consequently, the heat detected quantity Q3 is linked to the quantity of liquid in the channel 9: it is thus greater in case of absence of liquid.

Furthermore, the greater the second part Q2, the more rapidly the sensor 11 heats up and thus the higher the variation of temperature in time ΔT/Δt.

FIGS. 5 and 6 show, for example, the plot of temperature versus time ΔT/Δt in case of absence of liquid and presence of liquid, respectively; their comparison highlights the different behaviors in the two cases.

The present procedure of verification of absence/presence of liquid is fundamentally based upon the calculation of the variation of temperature ΔT/Δt (slope of the straight lines in FIGS. 5 and 6), considering the two limit cases of absence of liquid in the channel 9 (only air), and channel 9 completely filled.

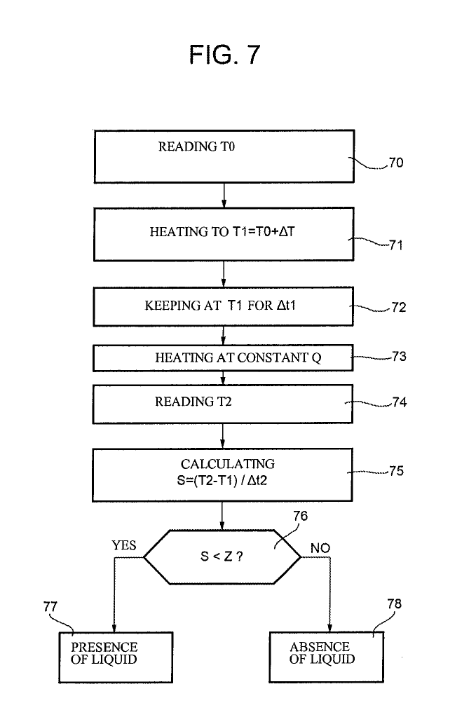

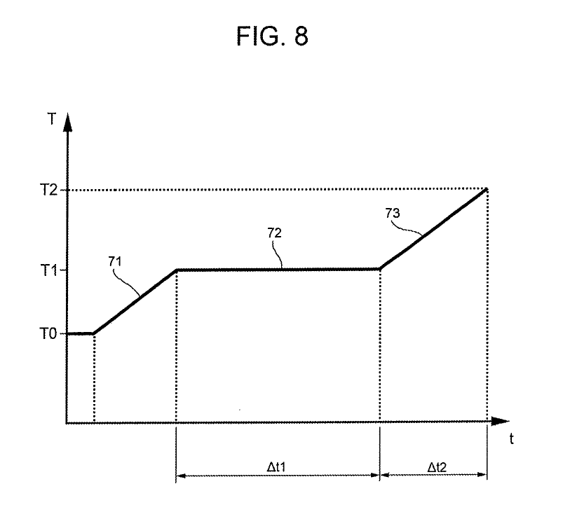

The algorithm 60 for detecting the liquid thus carries out the following steps (see FIGS. 7 and 8):
it reads the initial temperature T0 supplied by the sensor 11 (step 70);
it heats the channel 9 so as to bring it to a pre-heating temperature T1=T0+ΔT intended to rule out any influence by factors not linked to the instrumentation (step 71); in this step, the temperature detected by the sensors 11 is read repeatedly so as to control heating;
it maintains the pre-heating temperature T1 for a certain time interval Δt1 in order to stabilize the device in temperature (pre-heating step 72); also in this step, the temperature detected by the sensors 11 is read repeatedly so as to control heating;
it increases the temperature at constant heat Q irrespective of the characteristics of the device 1 (by supplying a PWM current with fixed and constant duty cycle, e.g., 50%, to the heaters 10), for a pre-determined time interval Δt2 (step 73);
it reads the new reached temperature T2 (detection step 74);
it calculates the slope S as the ratio (T2−T1)/Δt2 (step 75);
it compares the slope S calculated with a known threshold value Z (obtained via experimental tests) and corresponding to the slope in the absence of liquid (step 76);
if the slope S is smaller than K, it generates a message of presence of liquid, for example, supplied to the display 55 of FIG. 2 (step 77);
alternatively, it generates a message of absence of liquid (step 78).

For example, in a simulation conducted by the applicant, after reading the initial temperature, the channel 9 was heated to T1=40° C. by applying a PW-modulated current with a duty-cycle of 5% (for example, in a maximum power condition, the current may have an instantaneous value of 1.6 A. The modulation depends of course upon the difference between the target and the instantaneous temperature; in steady-state condition, the effective value is generally about 10% of the maximum value); the temperature T1 was maintained for Δt1=6 s; the chip was heated by sending a PWM current with duty-cycle of 50%; the new temperature T2 was read after a time interval Δt1 of 100 ms, and a threshold Z=70 was used. In general, from the simulations, it has been found that different values of Z, with 60<Z<70, can be used. In detail, if Z<60, the method detects the presence of liquid (channel 9 full); if Z>70 the method detects the absence of liquid (channel 9 empty). If 60<Z<70 the channel 9 is not completely full, and the introduced amount is smaller than the optimal one. It has in any case been found that these thresholds can undergo variations according to other characterizations.

Obviously, the algorithm 60 can be varied so as to be able to detect also the presence of a liquid amount other than zero, but smaller than the optimal one, in any case such as to enable a significant analysis, e.g., in the case where the optimal amount cannot be obtained. In this case, the algorithm 60 can use further thresholds, corresponding to various liquid levels, and the algorithm can supply this information to the operator so as to highlight the degree reliability of the result of the analysis.

In the case of absence of liquid, or in the case of a liquid amount considered insufficient by the operator, the latter can decide to interrupt the analysis procedure. Alternatively, in some cases, the analysis procedure can be interrupted automatically.

Consequently, in an application of the device, sequences of particular nucleic acids can be detected by using oligonucleotide probes. In this case, a specimen of raw biological material (e.g., blood) is introduced in the specimen reservoir 3 and is fed to the specimen-preparation portion 5. Then a separation of nucleated cells (e.g., white blood cells, separation of useful particles) is performed, and the biological specimen is combined with reagents for lysis and PCR, which are supplied by the reagent reservoir 4. Then, the biological specimen and the reagents are mixed, the cell nuclei are chemically broken up, and DNA is extracted. The DNA is then thermally denatured. The algorithm 60 determines whether there exists an amount of specimen sufficient for analysis. Then, if the outcome of the presence detection is positive, the liquid is amplified in the amplification chamber 6. At the end of the amplification step, the treated biological specimen is supplied to the detection chamber 7, for hybridization of target nucleotide sequences and their detection, according to the existing techniques and protocols.

The advantages of the present method and device emerge clearly from the foregoing description.

In particular, it is pointed out that the present method can be readily integrated with all the functions envisaged for identifying one or more specific oligonucleotide sequences in a specimen, including optionally the preparation of the specimen, in a miniaturized PCR reactor using a customized microarray. The device can be arranged on a slide of small dimensions capable of providing all the mechanical, thermal, fluidic, and electrical connections.

Finally, it is clear that modifications and variations may be made to the method for detecting the presence of liquids, to the detecting apparatus, and to the corresponding device, described and illustrated herein, without thereby departing from the scope of the present disclosure.

In particular, it is emphasized that the present method is applicable in principle to any lab-on-chip system or electronic device that requires manual intervention for introducing any liquid to be examined and the presence of which can be detected on the basis of thermal phenomena. Furthermore, the method for detecting the presence of liquids can be conducted immediately, before any treatment step, which is immediately interrupted in the case of lack or insufficiency of material, if heaters and sensors are present in the relevant area, in this case avoiding execution of useless operations and waste of reagents with no liquids. Alternatively, the check can be performed before or after amplification, to verify that the material amplified is in an amount sufficient for the subsequent analysis, as described above.

Finally, the step of heating the channel in step 73 can be replaced by cooling of the channel, using the cooling unit 56 since, also in this case, the thermal behavior varies as a function of the presence/absence of liquid.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
detecting a liquid in a channel, the detecting including;
detecting an initial temperature in the channel accommodating the liquid;
modifying the temperature in the channel for a test time;
detecting a test temperature;
determining a temperature variation based on the initial temperature, the test temperature and the test time; and
comparing the temperature variation with a threshold.

2. A method according to claim 1, further comprising, before detecting the initial temperature, reading an environment temperature; heating the channel to the initial temperature; and maintaining the channel at the initial temperature for a time period.

3. A method according to claim 1, wherein modifying the temperature in the channel comprises heating the channel by feeding a PWM-modulated current to a heater positioned under the channel.

4. A method according to claim 1, comprising generating a liquid-absence signal if the temperature variation is higher than the threshold.

5. A method according to claim 1, further comprising:
detecting a biological material in response to detecting the liquid in the channel, the detecting including performing an analysis on said biological material.

6. A method according to claim 5, further comprising:
separating useful particles in said liquid;
extracting biological material from the useful particles;
amplifying the biological material, after detecting the liquid.

7. An apparatus for detecting a liquid, comprising:
first detecting means for detecting an initial temperature in a channel accommodating the liquid;
means for modifying the temperature in the channel for a test time;
second detecting means for detecting a test temperature;
means for detecting a temperature variation based on the initial temperature, the test temperature and the test time; and
means for comparing the temperature variation with a threshold.

8. An apparatus according to claim 7, comprising a board reader configured for cooperating with a microfluidic device comprising the channel, and a processing unit coupled to the board reader, the processing unit including thermocycling means for controlling thermal heating and cooling cycles for the microfluidic device.

9. An apparatus according to claim 7, comprising temperature detecting means configured so as to cooperate with the microfluidic device.

10. A microfluidic device, comprising:
a channel configured to accommodate a liquide;
heaters arranged near the channel;
a temperature sensor arranged near the channel;
a controller coupled with the heaters and the temperature sensors and configured receive from the temperature sensor a first temperature indication of an initial temperature in the channel; cause the heaters to modify the temperature in the channel for a test time; receive from the temperature sensor a second temperature indication of a test temperature; determine a temperature variation based on the initial temperature, the test temperature and the test time; and compare the temperature variation with a threshold.

11. A microfluidic device according to claim 10, wherein the controller is configured to, before receiving the first temperature indication of the initial temperature, causing the heaters to heat the channel to the initial temperature and maintain the channel at the initial temperature for a time period.

12. A microfluidic device according to claim 10, wherein the heaters are positioned under the channel.

13. A microfluidic device according to claim 10, further comprising:
a biological material detector configured to detect a biological material by performing an analysis on said biological material, wherein the controller is configured to cause the biological material detector to detect the biological material in response to the controller detecting the liquid in the channel.

14. A non-transitory computer readable medium comprising instructions to cause a computing device to perform a method that includes:
detecting a liquid in a channel, the detecting including;
detecting an initial temperature in the channel accommodating the liquid;
modifying the temperature in the channel for a test time;
detecting a test temperature;
determining a temperature variation based on the initial temperature, the test temperature and the test time; and
comparing the temperature variation with a threshold.

15. The computer-readable medium of claim 14, wherein the method further includes, before detecting the initial temperature, reading an environment temperature; heating the channel to the initial temperature; and maintaining the channel at the initial temperature for a time period.

16. The computer-readable medium of claim 14, wherein the method further includes:
detecting a biological material in response to detecting the liquid in the channel, the detecting including performing an analysis on said biological material.
